(19) United States
(12) Patent Application Publication
(10) Pub. No.: US 2025/0220108 A1
(43) Pub. Date: Jul. 3, 2025

(54) SYSTEMS AND METHODS FOR DETECTING HANDLING EVENTS FOR PORTABLE DEVICES

(71) Applicant: Universal City Studios LLC, Universal City, CA (US)

(72) Inventors: David Gerard Majdali, Orlando, FL (US); Gregory Paul Habiak, Orlando, FL (US)

(21) Appl. No.: 18/902,440

(22) Filed: Sep. 30, 2024

Related U.S. Application Data
(60) Provisional application No. 63/640,773, filed on Apr. 30, 2024.
(60) Provisional application No. 63/615,647, filed on Dec. 28, 2023.

(51) Int. Cl. H04M 1/72454; H04M 1/72463; H04M 1/72484

(52) U.S. Cl. CPC H04M 1/72454; H04M 1/72463; H04M 1/72484

(57) ABSTRACT

An event detection system includes processing circuitry with one or more processors. The event detection system also includes memory storing instructions, that when executed by the processing circuitry, cause the processing circuitry to process positioning data for a portable device to identify an occurrence of an improper handling event for the portable device by a user, and update a user event profile for the user by adding the improper handling event to a quantity of improper handling events for the portable device by the user. The instructions, that when executed by the processing circuitry, cause the processing circuitry to apply one or more restrictions for the user in response to determining that the quantity of improper handling events for the portable device by the user meets or exceeds an event threshold.

### CROSS-REFERENCE TO RELATED APPLICATIONS

This application claims priority to and the benefit of U.S. Provisional Application No. 63/615,647, entitled “SYSTEMS AND METHODS FOR IMPACT DETECTION IN AN ENVIRONMENT” and filed Dec. 28, 2023, and also claims priority to and the benefit of U.S. Provisional Application No. 63/640,773, entitled “SYSTEMS AND METHODS FOR DETECTING HANDLING EVENTS FOR PORTABLE DEVICES” and filed Apr. 30, 2024, which are incorporated by reference herein in their entireties for all purposes.

### BACKGROUND

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

To improve guest experiences in an entertainment venue, the entertainment venue may include objects (e.g., props or toys) that provide special effects. For example, the special effects may provide customized special effects based on guests' experiences within the entertainment venue, as well as support a particular narrative in the entertainment venue. Additionally or alternatively, the objects may facilitate interactions between the guests and interactive elements in the entertainment venue. For example, the guests may perform particular gestures with the objects to cause animated characters to perform show effects.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, an event detection system includes processing circuitry with one or more processors. The event detection system also includes memory storing instructions that, when executed by the processing circuitry, cause the processing circuitry to process positioning data for a portable device to identify an occurrence of an improper handling event for the portable device by a user, and update a user event profile for the user by adding the improper handling event to a quantity of improper handling events for the portable device by the user. The instructions, when executed by the processing circuitry, cause the processing circuitry to apply one or more restrictions for the user in response to determining that the quantity of improper handling events for the portable device by the user meets or exceeds an event threshold.

In an embodiment, an event detection system includes processing circuitry with one or more processors. The event detection system also includes memory storing instructions that, when executed by the processing circuitry, cause the processing circuitry to dynamically set an event threshold, process respective data for a first portable device utilized during a respective first visit of a first user to a first interactive environment to identify an occurrence of a handling event for the first portable device by the first user, and update a user event profile for the first user by adding the handling event to a quantity of handling events by the first user. The instructions, when executed by the processing circuitry, cause the processing circuitry to apply one or more restrictions for the user or one or more enhancements for the user in response to determining that the quantity of handling events meets or exceeds the event threshold.

In an embodiment, a method of operating an event detection system includes processing, using one or more processors, positioning data for a portable device to identify an occurrence of an improper handling event for the portable device. The method also includes updating, using the one or more processors, an event profile by adding the improper handling event to a quantity of improper handling events for the portable device. The method further includes applying, using the one or more processors, one or more restrictions in response to determining that the quantity of improper handling events for the portable device meets or exceeds an event threshold.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an interactive system with an event detection system, in accordance with present embodiments;

FIG. 2 illustrates the event detection system utilized to generate a respective guest event profile for a guest based on handling of a portable device by the guest, in accordance with present embodiments;

FIG. 3 illustrates guests carrying portable devices within an interactive environment, in accordance with present embodiments;

FIG. 4 illustrates a first guest during a first visit to the interactive environment and during a second visit to the interactive environment, in accordance with present embodiments; and

FIG. 5 is an example of a graphical user interface (GUI) that presents a guest event profile for the first guest, in accordance with present embodiments.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. As used herein, machine learning may refer to algorithms and statistical models that computing systems may use to perform a specific task with or without using explicit instructions. For example, a machine learning process may generate a mathematical model based on a sample of clean data, known as “training data,” in order to make predictions or decisions without being explicitly programmed to perform the task.

The present disclosure relates generally to an interactive environment that utilizes portable devices to provide interactive experiences to guests (e.g., users). In an embodiment, the interactive environment is implemented within an amusement park attraction, such as in a ride attraction in which the guests are carried in ride vehicles through the interactive environment and/or a walk-through attraction in which the guests walk through the interactive environment. In an embodiment, the amusement park attraction may be a hybrid attraction in which the guests are both carried (e.g., on a moving walkway) and are permitted to walk (e.g., along the moving walkway) through the interactive environment. The interactive environment may be distributed across multiple different amusement park attractions (e.g., geographically separated from one another), such as across multiple different ride attractions, walk-through attractions, and/or hybrid attractions. Additionally or alternatively, the interactive environment may be implemented within one or more other types of venues, such as one or more restaurants, one or more hotels, one or more theatres, one or more stadiums, and/or one or more schools. Additionally or alternatively, the interactive environment may be included within one or more themed areas and/or distributed across multiple different themed areas having a common theme or different themes. Additionally or alternatively, the interactive environment may include a live show (e.g., with performers), and the guests in an audience may participate in the live show using the portable devices.

The portable devices may be any of a variety of types of devices that are configured to be carried, such as held and/or worn, by the guests. For example, the portable devices may include targeting devices (e.g., blasters), wands, toys, figurines, clothing, jewelry, bracelets, headgear, medallions, glasses (e.g., augmented reality (AR) and/or virtual reality (VR) glasses), and/or any combination thereof (e.g., targeting devices integrated into bracelets). In an embodiment, the portable devices may be configured to be used by multiple different guests over time. For example, a guest may pick up a portable device at an entrance to the interactive environment, use the portable device to participate in the interactive environment as the guest travels through the interactive environment, and then return the portable device as the guest exits the interactive environment. The portable device may be made available again at the entrance to the interactive environment (e.g., after cleaning and/or sterilizing), and then another guest may pick up the portable device at the entrance to the interactive environment and use the portable device to participate in the interactive environment, and so on.

In an embodiment, the portable devices may enable the guests to interact with (e.g., to control) features within the interactive environment. For example, a portable device may be a targeting device, and the guest may actuate an input mechanism (e.g., trigger switch, push-button) of the portable device to initiate a simulation of a delivery (e.g., virtual delivery) of a virtual projectile toward an interactive element (e.g., a physical interactive element in a physical, real-world space or a virtual interactive element in a virtual space on a display screen) within the interactive environment. In response, the interactive environment may portray the virtual projectile landing on (e.g., “striking” or “hitting”) the interactive element. For example, the display screen may display an image (e.g., moving image; video) that portrays the virtual projectile landing on (e.g., “striking” or “hitting”) a virtual interactive element. In another example, a change in the behavior of a physical interactive element or presence of special effects (e.g., sound, light, smoke, vibrations) in the interactive environment may indicate a successful targeting of the physical interactive element. In another example, successful targeting and/or timing of actuation of an input mechanism may include aiming at the interactive element and actuating the input mechanism while aiming at the interactive element. It should be appreciated that the physical interactive element may be a prop or a physical object in the physical, real-world space within the interactive environment, and the virtual interactive element may be an image/animation of a virtual object displayed in the virtual space on the display screen. In an embodiment, a hybrid interactive element may be a physical interactive element and a virtual interactive element simultaneously by having physical portions in the physical, real-world space within the interactive environment and virtual portions displayed in the virtual space on the display screen. Herein, “interactive element” generally refers to any physical interactive element, virtual interactive element, or hybrid interactive element.

In an embodiment, the portable devices may enable the guests to view virtual features (e.g., imagery) within the interactive environment. For example, a portable device may be a wearable visualization device (e.g., AR and/or VR glasses), such as a head mounted display that may be worn by the guest and may be configured to enable the guest to view the virtual features. In particular, the wearable visualization device may be utilized to enhance a guest experience by overlaying the virtual features onto a real-world environment, by providing adjustable virtual environments to provide different experiences, and so forth. As noted herein, the portable devices may include other types of devices, such as a wand or a bracelet that may be moved through space in a particular manner to initiate a change to the interactive element.

Advantageously, disclosed embodiments provide an event detection system (e.g., drop detection system) that is configured to monitor handling of the portable devices, such as whether the portable devices are improperly handled. For example, the portable devices may be considered to be improperly handled when the portable devices experience an adverse or potentially damaging event, such as a drop or a throw that results in contact with a surface, a spin or a swing that results in excessive acceleration over an acceleration threshold and/or that matches an acceleration signature, and/or a movement that results in incorrect direction of travel. It should be appreciated that the event detection system may monitor any of a variety of handling events that provide information and insight into actions of the guests, including proper handling events, such as properly returning the portable devices to a collection bin (e.g., with expected acceleration values and signatures, at appropriate times), traveling in a proper direction, and so forth. In an embodiment, the event detection system may include position circuitry, such as ultra-wideband (UWB) circuitry and/or inertial measurement units (IMU) and associated circuitry, that generates and/or indicates position data and/or orientation data for the portable devices.

In an embodiment, the position circuitry may include respective UWB tags, such as an array of UWB tags, on each of the portable devices, as well as UWB readers in the real-world environment. Communication between the UWB tags and the UWB readers may indicate the position data and/or the orientation data. Additionally or alternatively, the position circuitry may include respective IMUs on each of the portable devices to generate the position data and/or the orientation data. In some instances, signals generated by the UWB components may be processed to derive or estimate acceleration data and/or velocity data. When present, the IMUs may provide acceleration data and/or velocity data. In any case, the position circuitry may provide the position data, the orientation data, the acceleration data, and/or the velocity data to a control system (e.g., electronic control system), which may determine whether any of the portable devices are improperly handled and may cause one or more actions in response to determining that at least one of the portable devices is improperly handled.

It should be appreciated that techniques disclosed herein to monitor events for the portable devices may be performed without the IMUs or any accelerometers on the portable devices. For example, the portable devices may be devoid of the IMUs and the accelerometers. Instead, the position data, the orientation data, the acceleration data, and/or the velocity data may be obtained via radiofrequency communication circuitry, such as via the UWB circuitry that includes the UWB tags on the portable devices and the UWB readers in the real-world environment. In such cases, the portable devices may be lower cost and/or simpler (e.g., fewer components), and various processing aspects may be shifted to and performed at the control system.

It is presently recognized that certain motions of the portable devices may result in acceleration data that mimics or appears to be impact events. Accordingly, in an embodiment, the control system may reference a map (e.g., a virtual three-dimensional (3D) model) of the real-world environment to confirm (e.g., verify) that the portable devices impact a boundary to facilitate proper classification and/or counting of events (e.g., impact events, such as a drop or a throw that results in contact with a surface, as opposed to acceleration events, such as a spin or a swing that does not result in contact with the surface). The boundary may include a surface, such as a floor, a ceiling, a side wall, a physical interactive element, a display screen, and so forth. In an embodiment, the boundary may include the portable devices, the guests, and/or objects carried by the guests. For example, such features (e.g., the portable devices, the guests, and/or the objects carried by the guests) may be tracked and added to the map as dynamic features (e.g., movable features; movement caused by the guests and not according to programmed settings or paths).

In this way, for a particular usage of a particular portable device (e.g., a guest using the particular portable device during a visit to an interactive environment), the event detection system may identify each improper handling event based on data from the position circuitry. The event detection system may also classify each improper handling event, such as by determining that the improper handling event is an impact event with contact between the particular portable device and a boundary (e.g., by reference to the map). Further, the event detection system may increment a total quantity of events (e.g., add one to the total quantity of events) for the particular usage of the particular portable device, compare the total quantity of events to a threshold (e.g., event threshold), and implement a restriction in response to the total number or quantity of events meeting or exceeding the threshold. For example, the restriction may limit functionality of the particular portable device for some period of time or for a remainder of the visit to the interactive environment. Thus, the event detection system may encourage guests to properly handle (e.g., carefully handle) the portable devices, as the guests may have more interactive experiences and avoid restrictions if the total quantity of events remains below the threshold.

In an embodiment, the guest may register or otherwise link their account (e.g., their guest profile) to the particular portable device during the visit to the interactive environment, as well as to other portable devices during other visits to the interactive environment and/or additional interactive environments. Thus, over time, the event detection system may build and generate a respective event profile for the guest. For example, the respective event profile may indicate a respective total number or quantity of events per visit, over multiple visits, and so forth, and the respective event profile may be updated with each event. In this way, trends in events, behaviors, and so forth may be analyzed and assessed over time. In an embodiment, restrictions may be placed or implemented based on the respective event profile for the guest. For example, if the guest repeatedly exceeds the threshold over multiple visits to the interactive environment, the restrictions may be implemented to block entry of the guest to the interactive environment for some period of time, such as for a remainder of a current day. It should be appreciated that various types of restrictions are envisioned and are discussed in more detail herein.

In an embodiment, the threshold may be fixed. For example, the threshold may be fixed by an operator of the interactive environment and/or a manufacturer of the portable devices. In an embodiment, the threshold may be dynamic. For example, the threshold may vary based on a time of day, a special occasion (e.g., a themed party, a holiday), and so forth. In an embodiment, the threshold may be specific to the guest. For example, the threshold may vary based on an age of the guest, an experience level of the guest (e.g., number of visits), a history of events for the guest (e.g., a number of drop events at prior visits), a quantity and/or type of drinks consumed by the guest during a current day, and so forth. Additionally, the threshold may be updated over time, such as periodically or continuously based on new data related to events.

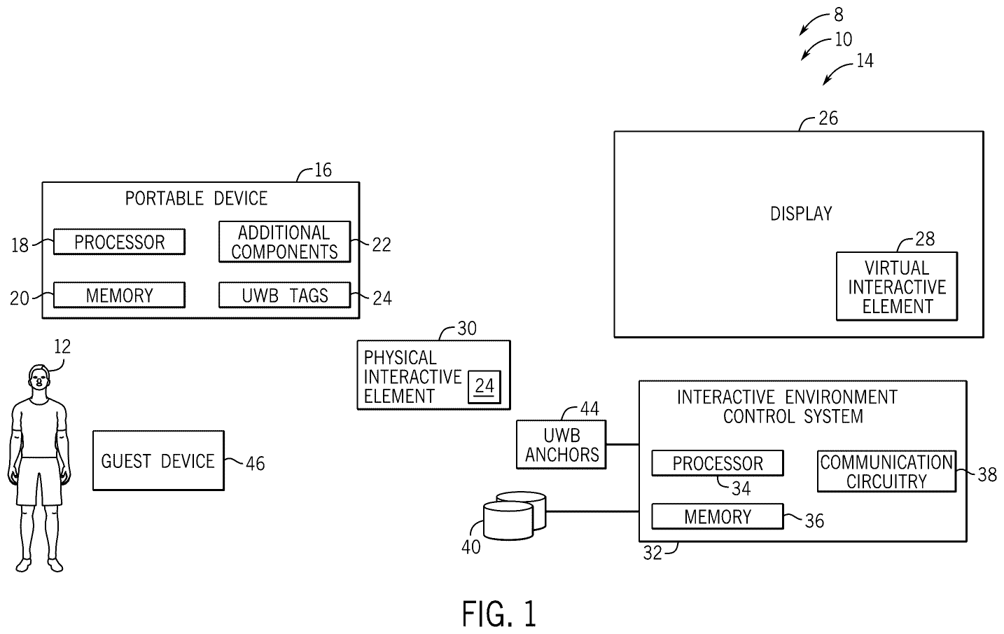

With the foregoing in mind, FIG. 1 illustrates an interactive system 8 with an event detection system 10, in accordance with an embodiment of the present disclosure. The interactive system 8 includes or is associated with an interactive environment 14, which may be within an amusement park attraction and/or other suitable venue. As shown, a guest 12 (e.g., user) may carry or otherwise be associated with a portable device 16 that includes a processor 18, a memory device 20, and additional components 22. The additional components 22 may include an input mechanism (e.g., trigger switch, push-button), a light emitter (e.g., light emitting diode [LED]), a haptic device, a display screen, a battery (and battery management system), a speaker, a microphone, an inertial measurement unit (IMU), a near-field communication (NFC) circuitry, and/or an ultra-high frequency (UHF) circuitry. In an embodiment, the portable device 16 may be used to interact with interactive elements (e.g., virtual interactive element 28, physical interactive element 30).

Advantageously, the portable device 16 may be equipped with ultra-wideband (UWB) tags 24 (e.g., antennas) that enable monitoring (e.g., continuous monitoring) of a position and/or an orientation of the portable device 16 (e.g., relative to a coordinate system; within the interactive environment 14). In addition, the UWB tags 24 may be part of a UWB circuitry (e.g., a UWB system) that generates and efficiently communicates position data and/or orientation data, which may enable an interactive environment control system 32 (also referred to herein as “a control system 32”) to accurately determine interaction with the interactive elements 28, 30 via the portable device 16 (e.g., successful targeting and/or gestures). The UWB tags 24 may be arranged to extend in two-dimensions or in three-dimensions (e.g., not in a linear row; in a cross-shape or an x-shape; along at least two of an x-axis, a y-axis, or a z-axis).

It should be appreciated that any other suitable components may be utilized to detect the position and/or the orientation of the portable device 16. For example, such components may include: one or more sensors, such as IMUs and/or accelerometers, on the portable device 16, and communication circuitry to send data from the one or more sensors to the control system 32; one or more sensors, such as imaging sensors/cameras, off-board the portable device 16 and in the interactive environment 14; one or more light emitters and one or more light detectors, such as one or more light emitters on the portable device 16 and one or more light detectors off-board the portable device 16 and in the interactive environment 14; and/or one or more light reflectors, one or more light emitters, and/or one or more light detectors, such as one or more retroreflectors on the portable device 16 and one or more light emitters off-board the portable device 16 to emit light toward the portable device 16 and one or more detectors off-board the portable device 16 to detect the light reflected by the one or more retroreflectors. However, in an embodiment, no light emitters, lasers, or line-of-sight sensing devices are utilized to detect the position and/or the orientation of the portable devices 16. Further, the UWB circuitry and/or the one or more sensors may be used to determine acceleration and/or velocity of the portable device 16. As noted herein, in some cases the portable device 16 may be devoid of the IMUs and the accelerometers, and instead the portable device 16 may utilize the UWB circuitry to monitor the position, the orientation, the acceleration, and/or the velocity of the portable device 16.

The interactive environment 14 may include one or more display screens 26 that are configured to display the virtual interactive elements 28. The virtual interactive elements 28 may include images (e.g., moving images; videos) of animated objects, such as symbols, coins/prizes, vehicles, characters, and the like. The virtual interactive elements 28 may move in two dimensions (2D) in the virtual space on the one or more display screens 26. In addition, the interactive environment 14 may include one or more of the physical interactive elements 30 that are placed or built into the interactive environment 14. The physical interactive elements 30 may include physical structures, props, vehicles, robots, and the like. The physical interactive elements 30 may move in three dimensions (3D) in the physical, real-world space within the interactive environment 14.

As the guest 12 travels through the interactive environment 14, the guest 12 may be presented with the interactive elements 28, 30. For example, images of animated objects may move across the one or more display screens 26, and/or robots may move in the interactive environment 14. The guest 12 may use the portable device 16 to virtually interact with the interactive elements 28, 30, such as by actuating the input mechanism on the portable device 16 to launch virtual projectiles toward the interactive elements 28, 30 and/or moving the portable device 16 through space to cause changes to the interactive elements 28, 30. In such cases, virtual projectiles may not have a physical embodiment or actual representation (e.g., virtual projectiles may not be seen or sensed; may not be present in the physical, real-world space and/or in the virtual space). However, in an embodiment, images of the virtual projectiles may be shown on the one or more display screens 26. In an embodiment, the interactive system 8 may award points (e.g., achievements) to the guest 12 for each successful interaction (e.g., each “strike” or target gesture) with the interactive elements 28, 30, and the points may be added to a guest event profile of the guest 12. The guest event profile of the guest 12 may be stored in one or more databases 40, such that the guest event profile of the guest 12 may be maintained and updated across multiple visits to the interactive environment 14.

The control system 32 may be responsible for controlling the physical interactive elements 30 and the virtual interactive elements 28 to produce responses to virtual interactions (also referred to herein as “interactions”) between the portable devices 16 and the interactive elements 28, 30 in the interactive environment 14. For example, the control system 32 may calculate trajectories of virtual projectiles with an aim of determining whether the virtual projectiles should be considered to reach a target, such as based on the position data and/or the orientation data during the actuation of the input mechanism.

The control system 32 may include a processor 34, a memory device 36, and communication circuitry 38 to enable the control system 32 to control features within the interactive environment 14, such as to control the interactive elements 28, 30 and/or produce special effects in the interactive environment 14, as well as to communicate with the portable device 16. The processor 34, the memory device 36, and the communication circuitry 38 may enable the control system 32 to receive and process the position data, the orientation data, the acceleration data, and/or the velocity data to determine occurrence of and count events, determine and track regions of impact during the impact events, and so forth.

The memory device 36 may include one or more tangible, non-transitory, computer-readable media that store instructions executable by the processor 34 and/or store data (e.g., guest event profile) to be processed by the processor 34. For example, the memory device 36 may include random access memory (RAM), read only memory (ROM), rewritable non-volatile memory such as flash memory, hard drives, optical discs, and/or the like. Additionally, the processor 34 may include one or more general purpose microprocessors, one or more application specific processors (ASICs), one or more field programmable gate arrays (FPGAs), or any combination thereof. Further, the memory device 36 may store instructions executable by the processor 34 to perform the methods and control actions described herein for the interactive system 8.

The control system 32 may be or represent a processing system (e.g., processing circuitry; computing system), including a cloud-computing system, a distributed computing system, or any suitable type of computing system. Further, the control system 32 may be or represent the processing system with the processor 34, which may include or represent multiple processors. In such cases, certain processing operations may be performed by one of the multiple processors, other processing operations may be performed by another of the multiple processors, and so forth. Additionally, it should be appreciated that processing operations may be divided and/or shared with the processor 18 of the portable device 16. Indeed, certain processing operations described herein may be performed by the processor 18 of the portable device 16 in certain circumstances or in certain configurations.

It is presently recognized that it would be desirable to monitor and track events of improper handling for the portable device 16. In an embodiment, one or more sensors of the additional components 22 of the portable device 16, such as the IMU, may detect an acceleration (e.g., a sudden acceleration or deceleration) or change in acceleration (e.g., an increase and/or decrease in acceleration) of the portable device 16. For example, if the guest 12 drops the portable device 16 (e.g., in free fall toward the ground/along a gravity vector), the one or more sensors may detect an acceleration and may provide signals to the processor 34, which may process the signals by comparing the acceleration (e.g., maximum acceleration value) to an acceleration threshold (e.g., acceleration threshold value). The processor 34 may be configured to determine that the portable device 16 has been dropped or thrown in response to determining that the acceleration exceeds the acceleration threshold. It should be appreciated that the acceleration is a broad term that encompasses various ways of detecting dropping and/or throwing (including similar motions, such as swinging), and thus, the acceleration may be negative and the acceleration threshold may be a negative acceleration threshold (e.g., due to falling) or the acceleration threshold may be considered to be a deceleration threshold (e.g., due to a sudden stop due to an impact).

The processor 34 may also be configured to determine and analyze the acceleration over time (e.g., acceleration pattern or signature) to determine whether the portable device 16 has been improperly handled, classify the handling event, and/or to identify impact with a boundary. It should be appreciated that the one or more sensors may additionally or alternatively detect various other parameters, such as deceleration, an angular rate, a velocity, a position, and/or an orientation of the portable device 16 (e.g., relative to the gravity vector), and the one or more sensors may provide signals to the processor 34 for analysis to determine whether the portable device 16 has been improperly handled, classify the handling event, and/or to identify an impact with the boundary.

In an embodiment, the UWB tags 24 of the portable device 16 may be detected by UWB anchors 44 in the interactive environment 14. In particular, the UWB tags 24 and UWB anchors 44, which are in communication with the control system 32, may be part of a real-time locating system that performs continuous location tracking (e.g., position and/or orientation tracking) of the portable device 16 within the interactive environment 14. For example, the UWB tags 24 on the portable device 16 may communicate with the UWB anchors 44, which may be distributed throughout the interactive environment 14, to send positioning data. The UWB anchors 44 may then send the positioning data to the processor 34.

In an embodiment, mapping of the interactive environment 14 may include mapping the physical interactive elements 30, surfaces (e.g., floor, ceiling, side walls) that define the interactive environment 14, and the portable device 16 to a coordinate system (e.g., local coordinate system). The mapping may also include mapping other features, such as other portable devices, the guest 12, other guests, items carried by the guest 12, and/or items carried by the other guests, for example. Further, the mapping may be dynamic and may account for movement of the physical interactive elements 30, the portable device 16, and the other features. In an embodiment, locations of the physical interactive elements 30 may be known without use of the UWB tags 24 (e.g., programmed movements as part of the show). In an embodiment, the locations of the physical interactive elements 30 may be determined based on detection of UWB tags and/or one or more sensors (e.g., on-board and/or off-board the physical interactive elements 30).

It should be appreciated that the locations of the other features may be determined in any of a variety of manners, such as via techniques described herein to monitor the position of the portable device 16 and/or computer vision techniques (e.g., analysis of images of the interactive environment 14), for example. In certain cases, the other features (or at least some of the other features, such as the guest 12, the other guests, the items carried by the guest 12, and/or items carried by the other guests) may not be incorporated into the mapping (e.g., may not be identified as boundaries); however, impact events with the other features may be identified or detected (e.g., count as impact events) based on data indicative of acceleration, position, and/or orientation of the portable device 16 and the other portable devices as carried through the interactive environment 14. For example, even if the other guests are not mapped, acceleration data indicative of an impact event of the portable device 16 and position data indicative of the portable device 16 being close to (e.g., within a threshold distance of) another portable device may indicate an impact event of the portable device 16 with another guest or item carried by another guest, and thus this may be counted as an impact event of the portable device 16.

The processor 34 may access a map of the interactive environment 14 to identify and/or to assess the handling events. For example, the processor 34 may utilize the positioning data indicated by the UWB circuitry to track the position and/or the orientation of the portable device 16 relative to boundaries indicated in the map. If the processor 34 determines that the positioning data indicates that the portable device 16 aligns with or meets one of the boundaries indicated in the map, the processor 34 may determine occurrence of the handling event as an impact event for the portable device 16. It should be appreciated that the processor 34 may also access a model (e.g., a three-dimensional (3D) model) of the portable device 16 to determine the occurrence of the impact event for the portable device 16. Further, the processor 34 may track the handling events for the portable device 16 to generate a respective device event profile for the portable device 16, as a respective guest event profile for the guest 12 handling the portable device.

In an embodiment, the guest 12 may carry a guest device 46 (e.g., user device; mobile phone) that communicates with the portable device 16 and/or the control system 32. For example, the guest device 46 may provide an identifier (e.g., unique identifier) of the guest 12 to the portable device 16 and/or the control system 32 to thereby link and/or enable updates to the respective guest event profile of the guest 12 as the guest 12 uses the portable device 16 in the interactive environment 14 (e.g., during a particular visit). In certain embodiments, the guest device 46 may provide the identifier of the guest 12 to the portable device 16 (e.g., via appropriate wireless communication protocol, such as via Bluetooth or near field communication (NFC)), and then the portable device 16 may convey the identifier of the guest 12 with a device identifier of the portable device 16 to the control system 32 (e.g., via the UWB circuitry). In this way, the processor 34 may then track the handling events for the portable device 16 and update the respective guest event profile for the guest 12 handling the portable device 16. Further, this may be repeated for each visit of the guest 12 to the interactive environment 14 (and/or additional interactive environments) such that the processor 34 may then track the handling events for the guest 12 over multiple visits and update the respective guest event profile for the guest 12 based on the multiple visits (e.g., over time). In an embodiment, the processor 34 may provide the respective guest event profile, as well as other notifications (e.g., to indicate one or more restrictions; warnings that the guest 12 is approaching the threshold and will soon have one or more restrictions; warnings that the guest 12 has reached the threshold and now has the one or more restrictions), to the guest device 46 for display on the guest device 46. It should be appreciated that any suitable communication pathway is envisioned, such as the guest device 46 may receive the device identifier from the portable device 16 and then provide the device identifier with the identifier of the guest 12 to the control system 32 (e.g., via a Wi-Fi network).

It should be appreciated that the processor 34 may also consider the data provided by the one or more sensors of the additional components 22 of the portable device 16, for example, including the acceleration data provided by the IMU. For example, the acceleration data may indicate a time of contact between the portable device 16 and the surface (e.g., a time of impact) and/or other information about the handling event (e.g., a force of impact and/or a velocity at the time of impact for an impact event). In an embodiment, a sudden change in the acceleration may trigger assessment of the positioning data indicated by the UWB circuitry to determine whether the portable device 16 aligned with one of the boundaries indicated in the map. For example, upon or in response to the sudden change in the acceleration, the processor 34 may access and analyze the positioning data for some period of time before and after the sudden change in the acceleration to determine whether the portable device 16 aligned with one of the boundaries indicated in the map and whether the sudden change in acceleration should be counted as an impact event or counted as motion in space without impact (e.g., a quick change of direction caused by a user redirecting the portable device 16). By analyzing the positioning data and the one of the boundaries indicated in the map in response to the acceleration (e.g., only in response to or following the acceleration), the processor 34 may conserve processing power and resources (e.g., instead of continuously analyzing the positioning data and the map).

In an embodiment, the additional components 22 may include one or more feedback devices, such as one or more light emitters, one or more haptic devices, one or more display screens, and/or one or more speakers. The one or more feedback devices of the portable device 16 may provide various types of feedback (e.g., special effects) to the guest 12 based on the interaction between the portable device 16 and interactive elements in the interactive environment 14. Additionally or alternatively, the one or more feedback devices may provide respective feedback as alerts, such as alerts that maintenance is approaching and/or due for the portable device 16.

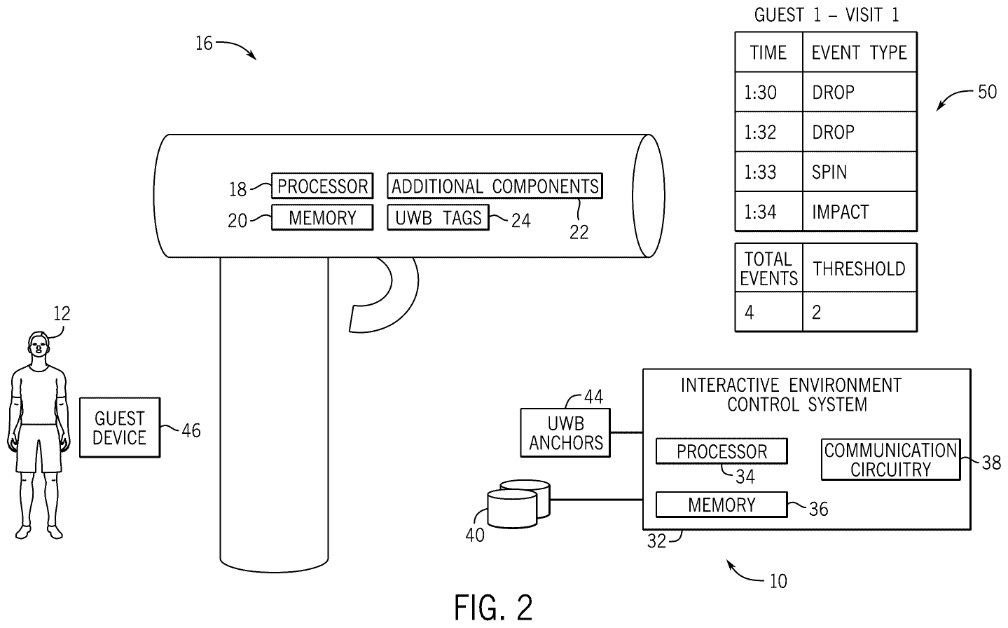

FIG. 2 illustrates the event detection system 10 utilized to generate a respective guest event profile 50 for the guest 12 based on handling of the portable device 16 by the guest 12, in accordance with present embodiments. As shown, the portable device 16 has a form of a handheld portable device and is associated with a respective guest event profile 50 for the guest 12 of FIG. 1; however, it should be appreciated that the portable device 16 may have any other suitable form as disclosed herein.

As described, the control system 32 may track events for the portable device 16, including for each usage of the portable device 16 in the interactive environment 14 of FIG. 1 (e.g., for each visit or pass through the interactive environment 14). For example, the processor 34 may analyze the positioning data generated by the UWB circuitry, analyze the acceleration data generated by the IMU, and/or reference the map of surfaces in the interactive environment. Then, the processor 34 may count the handling event, such as by adding one event to a total quantity of events for the portable device 16. For example, if the processor 34 determines that the portable device 16 is dropped to a floor, the processor 34 may log the handling event and also add one event to the total quantity of events. In an embodiment, the processor 34 may classify the handling event, such as an impact event, a throw event, a drop event, a swing event, a spin event, and/or an incorrect direction event. In some such cases, the processor 34 may also separately track or count different types of events, such as to add one drop event to a total quantity of drop events for the portable device 16. In an embodiment, the processor 34 may also log a time (e.g., coordinated universal time and/or relative time during the usage of the portable device) for each event.

As described herein, the portable device 16 may be linked (e.g., temporarily linked) to the guest 12 as the guest 12 carries the portable device 16 through the interactive environment 14. For example, the guest 12 may select or pick up the portable device 16 prior to entering, or as entering, the interactive environment 14, then the guest 12 may use the portable device 16 to interact with the interactive environment 14, and then the guest 12 may deposit or return the portable device 16 before exiting, or as exiting, the interactive environment 14, so that the portable device 16 may be reused subsequently by other guests. As described herein, the portable device 16 may be linked to the guest 12 via any of a variety of techniques, such as via communication between the guest device 46 and the portable device 16 and/or the control system 32. For example, the guest device 46 may provide the identifier of the guest 12 to the portable device 16 and/or the control system 32 to thereby link and/or enable access and updates to the respective guest event profile 50 of the guest 12 as the guest 12 uses the portable device 16 in the interactive environment 14 (e.g., during a particular visit).

In this way, the processor 34 may then track the handling events for the portable device 16 and update the respective guest event profile for the guest 12 handling the portable device 16. Further, this may be repeated for each visit of the guest 12 to the interactive environment 14 (and/or additional interactive environments), such that the processor 34 may then track the handling events for the guest 12 over multiple visits and update the respective guest event profile 50 for the guest 12 based on the multiple visits (e.g., over time). In an embodiment, the processor 34 may provide the respective guest event profile 50 and/or other notifications (e.g., to indicate restrictions) to the guest device 46 for display on the guest device 46. Thus, the guest 12 may be able to view event status (e.g., event information, such as a quantity, type, time, and/or other data), restrictions, and/or other information via the guest device 46 upon request (e.g., guest input to the guest device 46) and/or in real time as the guest 12 travels through the interactive environment 14 (e.g., in response to each occurrence or detection of events; in response to application of restrictions).

Additionally or alternatively, the processor 34 may provide the respective guest event profile 50 and/or the other notifications to the display of the portable device 16 in a same or similar manner. Indeed, the processor 34 may provide alerts, such as audio alerts, haptic alerts, and/or visual alerts, for example, via the additional components 22 (FIG. 1) of the portable device 16 to notify the guest 12 and/or other individual (e.g., an operator at the interactive environment 14) of detection of improper handling of the portable device 16. A respective alert may be provided in response to each occurrence or detection of the improper handling of the portable device 16, which may help the guest 12 learn movements that are considered to be improper handling, and may also help discourage the guest 12 from continuing such movements.

The processor 34 may generate and/or reference a threshold (e.g., event threshold), and the processor 34 may implement or apply one or more restrictions based on a comparison of the handling events (e.g., the handling events during the usage or the particular visit) to the threshold. For example, the processor 34 may implement or apply one or more restrictions in response to the total quantity of events meeting or exceeding the threshold. In an embodiment, the one or more restrictions may limit functionality of the portable device 16 for some period of time or for a remainder of the usage (e.g., the particular visit) in the interactive environment 14. Accordingly, such techniques may encourage the guest 12 to properly handle (e.g., carefully handle) the portable device 16, as the guest may have more interactive experiences and avoid restrictions if the total quantity of events remains below the threshold.

In an embodiment, the threshold may be fixed. For example, the threshold may be selected by an operator of the interactive environment 14 and/or a manufacturer of the portable device 16. As another example, the threshold may be calculated based on modeled data and/or empirical data, such as based on an average or a median quantity of events detected during a trial period (e.g., initial period during which test subjects and/or a sample of guests use the portable devices in the interactive environment 14).

In an embodiment, the threshold may be dynamic. For example, the threshold may vary based on a time of day, a special occasion (e.g., a themed party, a holiday), and so forth. In certain cases, the threshold may be higher at night and/or during special occasions, as more events are expected at night due to the guest 12 being more fatigued and/or during the special occasions due to the guest 12 being distracted. In certain cases, the threshold may be lower at night and/or during the special occasions, to encourage the guest 12 to focus on proper handling of the portable device 16 while subject to fatigue and distraction. Similar to above, the threshold may be changed by the operator of the interactive environment 14 and/or the manufacturer of the portable device 16 (e.g., multiple respective thresholds may be set for various circumstances). Further, similar to above, the threshold may be calculated and changed based on modeled data and/or empirical data, such as based on a respective average or a respective median quantity of events detected during respective trial periods (e.g., initial periods during which test subjects and/or a sample of guests use the portable devices in the interactive environment 14 under various circumstances, such as during different times of day, different special occasions, and so forth). Additionally, the threshold may be updated over time, such as periodically or continuously based on new data related to events.

In an embodiment, the threshold may be specific to the guest 12. For example, the threshold may vary based on an age of the guest 12, an experience level of the guest 12 (e.g., number of visits), a history of events for the guest 12 (e.g., a quantity of drop events at prior visits), a quantity and/or type of drinks consumed by the guest 12 during a current day, and so forth. In certain cases, the threshold may be higher for children as compared to adults, as it is expected that children may drop the portable device 16 more and that such drops may be less damaging due to children typically dropping from heights that are closer to the ground. In certain cases, the threshold may be lower for the guest 12 with experience, the guest 12 with a history of multiple drop events, and/or the guest 12 with multiple drinks consumed, to encourage the guest 12 to focus on proper handling of the portable device 16. For example, at least certain purchases made by the guest 12 may be logged in a purchase section of the respective guest event profile 50 (e.g., via ordering and/or payment through an application on the user device), and the processor 34 may identify drinks consumed by the guest 12 as the drinks purchased by the guest 12 and adjust the threshold accordingly. Similar to above, the threshold may be changed by the operator of the interactive environment 14 and/or the manufacturer of the portable device 16 (e.g., multiple respective thresholds may be set for various guest characteristics). Further, similar to above, the threshold may be calculated and changed based on modeled data and/or empirical data, such as based on a respective average or a respective median quantity of events detected during respective trial periods (e.g., initial periods during which test subjects and/or a sample of guests use the portable devices in the interactive environment 14 under various circumstances, such as different ages, different drink consumption, and so forth). Additionally, the threshold may be updated over time, such as periodically or continuously based on new data related to events (e.g., update the threshold to correspond to a respective average or a respective median quantity of events detected during some time period). In an embodiment, the threshold may be updated during a visit to the interactive environment 14. However, in some cases, the threshold may be set prior to or at some initial portion of the visit to the interactive environment 14 (e.g., prior to or when the guest 12 picks up the portable device 16 and/or in response to the guest 12 providing inputs to link their account to the portable device 16) and may not change during the visit to the interactive environment 14.

Further, it should be appreciated that combinations of thresholds may be implemented, such as one threshold for drops, one threshold for other impacts, one threshold for spins, and so forth. Then, the one or more restrictions may be implemented in response to any one type of event exceeding its respective thresholds, various combinations of events exceeding various combination thresholds, and so forth. For example, the one or more restrictions may be implemented in response to any one of the following: two drops (e.g., a drop threshold of two), one drop and two spins (e.g., a combination threshold of two), three spins (e.g., a spin threshold of three), and so forth. In an embodiment, the processor 34 may also consider other data, such as an acceleration value, in order to trigger implementation of the one or more restrictions. For example, two spins with a first, lower acceleration may trigger the one or more restrictions, while one spin with a second, higher acceleration may trigger the one or more restrictions.

In an embodiment, the one or more restrictions may be implemented to encourage proper handling of the portable device 16 by the guest 12. As such, the one or more restrictions may include changes (e.g., negative changes) to interactions and/or effects provided to the guest 12 in the interactive environment 14, adjusting a way in which achievements are reached by the guest 12 in the interactive environment 14, reducing operational features of the portable device 16, reducing a quantity and/or changing a type of virtual projectiles available to the portable device 16, adjusting a target value (e.g., points) of virtual targets in the interactive environment 14, reducing points and/or disabling an ability to accumulate points in the interactive environment 14 (e.g., reset score to zero, set final score to zero, or block increase to the score), deletion of the visit and metrics (e.g., the score) thereof from the respective guest event profile 50, removal of the portable device 16 from the guest 12, and/or substitution of another object for the portable device 16.

In an embodiment, the one or more restrictions may apply outside of the interactive environment 14, such as by banning the guest 12 from (e.g., blocking entrance to or participation in) the interactive environment 14 and/or other interactive environments for some period of time, such as for an hour, a portion of a current day, a remainder of the current day, a portion of a subsequent day, an entirety of the subsequent day or visit, or some other quantity of subsequent days. In an embodiment, the one or more restrictions may include banning the guest 12 from a venue (e.g., an amusement park) that includes the interactive environment 14 for some period of time, such as any period of time noted above. In an embodiment, the one or more restrictions may include adjusting (e.g., blocking) access to one or more queues, such as via removing or reducing options for express line queues (e.g., making a virtual icon to request such express line queues unavailable in an application on the guest device 46), providing longer queues or wait times to the guest 12 (e.g., via the application on the guest device 46) for existing reservations and/or for future requests, and so forth. In some such cases, the lack of express line queues and/or the longer queues may be for other attractions (e.g., other interactive environments) that do not include or utilize portable devices carried by guests, as this may force or encourage the guest 12 to visit the other attractions that do not include or utilize the portable devices carried by guests and may therefore reduce improper handling of the portable devices over time.

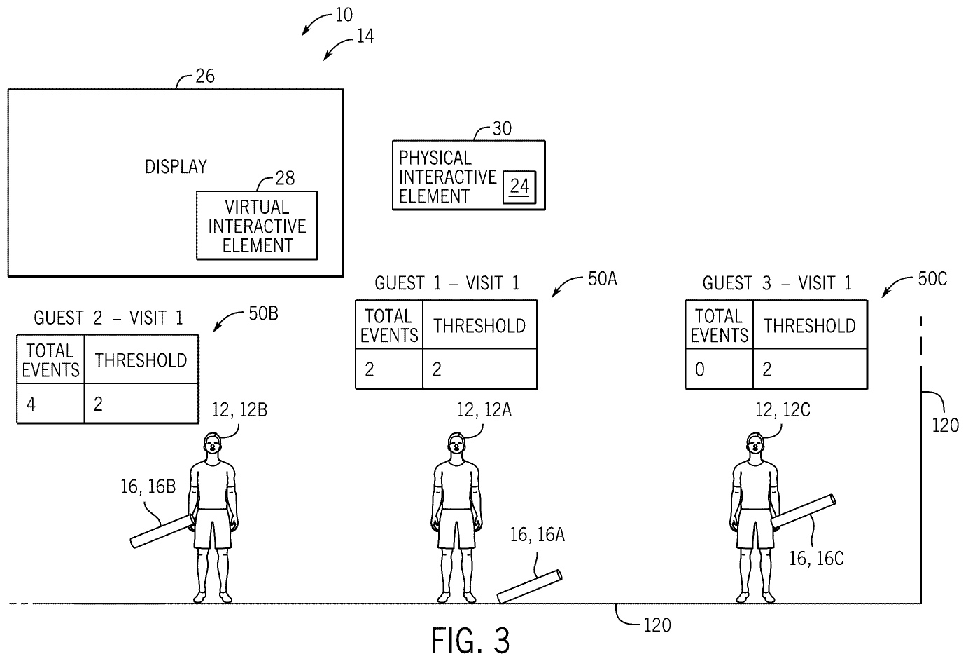

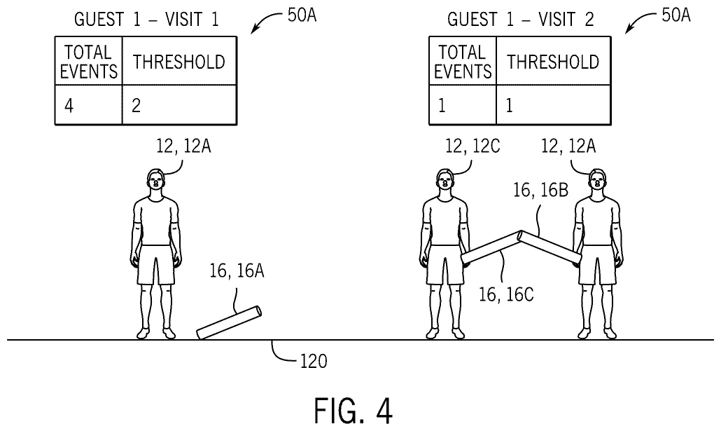

In an embodiment, the one or more restrictions may apply or extend to companions of the guest 12 (e.g., other guests sharing a ride vehicle or traveling as a group through the interactive environment 14 and/or other guests linked to the respective guest event profile 50 of the guest 12), such as changes (e.g., negative changes) to interactions and/or effects provided to the companions of the guest 12 in the interactive environment 14, adjusting the way in which achievements are reached by the companions of the guest 12 in the interactive environment 14, reducing a quantity and/or changing a type of virtual projectiles available to respective portable devices carried by the companions of the guest 12, and/or any other restrictions described herein. Additional examples of the one or more restrictions are described with reference to FIGS. 3 and 4.

It should be appreciated that, in an embodiment, certain events may result in enhancements rather than restrictions. For example, the processor 34 may distinguish accidental events from intentional events, such as based on the position and/or the orientation of the portable device 16, acceleration patterns, characteristics of the guest 12 (e.g., accessed from portions of the respective guest event profile 50 and/or estimated based on performance or gameplay in the interactive environment 14), and so forth. For example, the processor 34 may determine that the guest 12 is a child if the position of the portable device 16 is closer to a floor, the orientation of the portable device 16 is consistently pointed toward the floor, and the portable device 16 frequently contacts the floor (e.g., it may be more difficult for the child to lift the portable device 16). In such cases, the processor 34 may determine that drop events or impact events are accidental events, and the processor 34 may enhance interactions and/or effects provided to the guest 12 in the interactive environment 14, increase opportunities for achievements to be reached by the guest 12 in the interactive environment 14, increase operational features of the portable device 16, increase a quantity and/or change a type of virtual projectiles available to the portable device 16, increasing a target value (e.g., points) of virtual targets in the interactive environment 14, and so forth.

In a similar manner, the processor 34 may reward the guest 12 for properly handling the portable device 16 (e.g., over the visit and/or prior visits). For example, the processor 34 may determine that the guest 12 linked to the portable device 16 has not exceeded thresholds and/or has not improperly handled (e.g., no events) portable devices on prior visits to the interactive environment 14 (or to other interactive environments). Accordingly, the processor 34 may enhance interactions and/or effects provided to the guest 12 in the interactive environment 14, increase opportunities for achievements to be reached by the guest 12 in the interactive environment 14, increase operational features of the portable device 16, increase a quantity and/or change a type of virtual projectiles available to the portable device 16, increase a target value (e.g., points) of virtual targets in the interactive environment 14, provide opportunities or availability for express queues and/or shorter wait times for existing reservations and/or future requests, and so forth. In some cases, the reward to the guest 12 may include certain aspects that make the usage of the portable device 16 more challenging, such as removing a reticle on the portable device 16 and/or causing the virtual targets to move more quickly. However, when the guest 12 is experienced and has demonstrated proper handling of the portable device 16, such changes may be desirable to the guest 12.

It should be appreciated that improper handling of the portable device 16 may be detected in other ways, such as via liquid sensors that detect presence of liquid on a surface of a housing of the portable device 16 and/or liquid intrusion into the housing of the portable device 16 during the usage of the portable device 16. In such cases, the processor 34 may implement the one or more restrictions in response to detection of the liquid. Additionally, while certain examples provided herein relate to detecting occurrence of improper handling events, it should also be appreciated that the processor 34 may implement the one or more restrictions based on confirmed damage to the portable device 16. For example, an operator and/or a testing apparatus may test the portable device 16 after the usage by the guest 12. If the portable device 16 is determined to be damaged, the processor 34 may receive input indicative of the damage and may implement the one or more restrictions, even without detecting the improper handling as described herein. In an embodiment, the processor 34 may implement a first level of restrictions (e.g., during the usage; lower level, such as shorter times for the guest 12 to be banned) in response to the handling events exceeding the threshold (e.g., the improper handling), and a second level of restrictions (e.g., after the usage; higher level, such as longer times for the guest 12 to be banned) in response to identification of the damage to the portable device 16.

FIG. 3 illustrates multiple guests 12 carrying respective portable devices 16 within the interactive environment 14, in accordance with present embodiments. As shown, the guests may include a first guest 12A, a second guest 12B, and a third guest 12C. The first guest 12A has or is associated with a first portable device 16A, the second guest 12B has or is associated with a second portable device 16B, and the third guest 12C has or is associated with a third portable device 16C.

In operation, the first guest 12A may move the first portable device 16A to interact with interactive elements in the interactive environment 14. However, the first guest 12A may improperly handle the first portable device 16A multiple times, such as by dropping the first portable device 16A onto a floor that is a detection boundary 120 due to losing grip on the first portable device 16A or for various other reasons. In such cases, the event detection system 10 described herein may count the total quantity of events and compare the total quantity of events to the threshold. In FIG. 3, the total quantity of events for the first portable device 16A of the first guest 12A is two events, and the threshold is set at two events. Accordingly, the processor 34 may implement the one or more restrictions for the first guest 12A. For example, the one or more restrictions may include reducing special effects provided for the first guest 12A via the virtual interactive elements 28 and/or the physical interactive elements 30, such as by reducing movement of the virtual interactive elements 28 and/or the physical interactive elements 30 visible to the first guest 12A.

As noted herein, the one or more restrictions may additionally or alternatively include: adjusting a way in which achievements are reached by the first guest 12A in the interactive environment 14, such as by blocking ability to earn points by targeting the virtual interactive element 28; reducing operational features of the first portable device 16A, such as by disabling the display screen, disabling a trigger to launch the virtual projectiles, and/or blocking or removing a reticle; reducing a quantity and/or changing a type of virtual projectiles available to the first portable device 16A, such as by providing only five virtual projectiles instead of ten during the usage of the first portable device 16A by the first user and/or providing only basic virtual projectiles (e.g., round balls) instead of advanced virtual projectiles (e.g., flaming arrows); reducing a target value (e.g., points) obtained via “striking” the virtual interactive element 28 and/or the interactive physical element 24 in the interactive environment 14; reducing points and/or disabling ability to accumulate points in the interactive environment 14; deletion of the visit and metrics (e.g., the score) thereof from a first guest event profile 50A of the first guest 12A; removal of the first portable device 16A from the first guest 12A, and/or substitution of another object for the first portable device 16A (e.g., less expensive and/or lighter weight object; without the operational features of the first portable device 16A). It should be appreciated that the one or more restrictions may include any restrictions disclosed herein.

As shown, the second guest 12B may move the second portable device 16B to interact with the interactive elements 28, 30 in the interactive environment 14. However, the second guest 12B may improperly handle the second portable device 16B multiple times, such as by swinging the second portable device 16B. In such cases, the event detection system 10 described herein may count the total quantity of events and compare the total quantity of events to the threshold. In FIG. 3, the total quantity of events for the second portable device 16B of the second guest 12B is four events, and the threshold is set at two events. Accordingly, the processor 34 may implement the one or more restrictions for the second guest 12B. For example, the one or more restrictions may include any restrictions noted above for the first guest 12A. However, in some cases, the respective restrictions for the first guest 12A may be at a lower level as compared to the respective restrictions for the second guest 12B, as the first guest 12A exceeds the threshold by less than the second guest 12B. For example, the first guest 12A may experience limited special effects on the one or more display screens 26, while the second portable device 16B may be inoperable due to locking of the trigger of the second portable device 16B.

In operation, the third guest 12C may move the third portable device 16C to interact with the interactive elements 28, 30 in the interactive environment 14. However, the third guest 12C may properly handle the third portable device 16C, such that no events are detected and/or such that the total quantity of events is below the threshold. In FIG. 3, the total quantity of events for the third portable device 16C of the third guest 12C is zero events, and the threshold is set at two events. Accordingly, the processor 34 may not implement the one or more restrictions for the third guest 12C.

In certain embodiments, the processor 34 may implement one or more enhancements for the third guest 12C. The one or more enhancements may include: enhancing interactions and/or effects provided to the third guest 12C in the interactive environment 14, such as additional special effects visible to the third guest 12C; providing more opportunities for achievements to be reached by the third guest 12C in the interactive environment 14, such as more virtual interactive elements 28 for “striking” by virtual projectiles launched from the third portable device 16C; increasing operational features of the third portable device 16C, such as adding haptic effects or adding a reticle; increasing quantity and/or changing a type of virtual projectiles available to the third portable device 16C, such as providing advanced virtual projectiles (e.g., flaming arrows); increasing a target value (e.g., points) of virtual targets in the interactive environment 14; providing opportunities or availability for express queues and/or shorter wait times, and so forth. It should be appreciated that the one or more enhancements may include any enhancements disclosed herein. Further, the one or more enhancements or the reward to the third guest 12C may include certain aspects that make the usage of the third portable device 16C more challenging, such as causing the virtual interactive elements 28 to move more quickly. However, when the third guest 12C is experienced and has demonstrated proper handling of the third portable device 16C, such changes may be desirable to the third guest 12C. In FIG. 3, the threshold is uniform across all of the guests 12; however, the threshold may be fixed, dynamic, and/or guest-specific, as described herein.

FIG. 4 illustrates the first guest 12A with the first portable device 16A during a first visit to the interactive environment 14 and with the second portable device 16B during a second visit to the interactive environment 14, in accordance with present embodiments. While this example includes the first guest 12A obtaining and using different portable devices (e.g., the first portable device 16A and the second portable device 16B) to facilitate discussion, it should be appreciated that it is possible that the guest 12 may obtain and use a same portable device (e.g., the first portable device 16A during both visits). Further, while this example includes the first guest 12A obtaining and using different portable devices (e.g., the first portable device 16A and the second portable device 16B) in the interactive environment 14 to facilitate discussion, it should be appreciated that similar monitoring may be applied to track events for the guest 12 in different interactive environments (e.g., the interactive environment 14 and another interactive environment, which may utilize same or different types of portable devices, such as any targeting devices, AR/VR headsets, wands, medallions, and so forth).

During the first visit, the first guest 12A may move the first portable device 16A to interact with interactive elements in the interactive environment 14 (FIG. 1). However, the first guest 12A may improperly handle the first portable device 16A multiple times, such as by dropping the first portable device 16A onto a floor that is a detection boundary 120 due to losing grip on the first portable device 16A or for various other reasons. In such cases, the event detection system 10 (FIG. 1) described herein may count the total quantity of events and compare the total quantity of events to the threshold. In FIG. 4, during the first visit, the total quantity of events for the first portable device 16A of the first guest 12A is four events, and the threshold is set at two events. Accordingly, the processor 34 may implement the one or more restrictions for the first guest 12A during the first visit. During the first visit, the threshold may be set to a default threshold (e.g., that is applied to all guests during respective first visits).

During the second visit, the first guest 12A may move the second portable device 16B to interact with interactive elements in the interactive environment 14 (FIG. 1). However, the first guest 12A may improperly handle the second portable device 16B, such as by allowing or causing contact between the second portable device 16B and another object, such as the third portable device 16C carried by the third guest 12C. In such cases, the event detection system 10 described herein may count the total quantity of events and compare the total quantity of events to the threshold. In FIG. 4, during the second visit, the total quantity of events for the second portable device 16B of the first guest 12A is one event, and the threshold is set at one event. Accordingly, the processor 34 may implement the one or more restrictions for the first guest 12A during the second visit. Further, as the location, orientation and acceleration of the portable devices are known (e.g., determined as described herein), a detection of an impact event between the second portable device 16B and the third portable device 16C may indicate or include information regarding where on each of the second portable device 16B and the third portable device 16C the impact occurred (e.g., a respective location or area on the second portable device 16B and a respective location or area on the third portable device 16C) and severity of the impact.

This information may be utilized to adjust an experience of the first guest 12A and the second guest 12B, as described herein. In an embodiment, the impact event classified as having a first severity (e.g., low severity) may “count” as one impact event as described herein; however, the impact event classified as having a second severity (e.g., high severity) may “count” as multiple impact events for purposes of tracking the total quantity of events and comparison to the threshold. In an embodiment, the impact event classified as having the first severity may “count” as one impact event as described herein and result in no adjustments to the experience until the total quantity of events reaches the threshold; however, the impact event classified as having the second severity may result in immediate adjustments to the experience (e.g., disable the second portable device 16B and the third portable device 16C). In an embodiment, multiple or combination thresholds may be implemented, such as a first threshold for impact events with the first severity and a second threshold for impact events with the second severity. Further, this information may be utilized to determine or recommend appropriate maintenance procedures for the second portable device 16B and the third portable device 16C (e.g., via notification to an operator of the interactive environment 14).

As shown, the threshold (e.g., first threshold; default threshold) during the first visit may be different than the threshold (e.g., second threshold; updated threshold) during the second visit. For example, the threshold during the second visit may be lower than the threshold during the first visit due to adjustments based on a time of day, a special occasion, a history of improper handling by the first guest 12A (e.g., due to the first guest 12A exceeding the threshold during the first visit), and/or other data (e.g., drinks consumed by the first guest 12A). It should be appreciated that the threshold during the second visit may be applied to all guests at a particular time, or the threshold during the second visit may be specific to the first guest 12A. In this way, the threshold may vary during different visits to the interactive environment 14.

While FIG. 4 illustrates the first guest event profile 50A of the first guest 12A with indications of a respective total quantity of events and a respective threshold for the first guest 12A, it should also be appreciated that the third guest 12C may also have the third guest event profile 50C with indications of a respective total quantity of events and a respective threshold for the third guest 12C. Further, the contact between the second portable device 16B associated with the first guest 12A and the third portable device 16C associated with the third guest 12C may result or cause an increase (e.g., increment by one) to the respective total quantity of events in the first guest event profile 50A of the first guest 12A and the respective total quantity of events in the third guest event profile 50C of the third guest 12C. Further, the interactive system 10 (FIG. 1) described herein may additionally or alternatively detect count impact events of the portable devices 16 with the guests 12, other items carried by the guests 12 (e.g., backpacks, purses, toys, and/or mobile phones carried by the guests 12), and so forth.

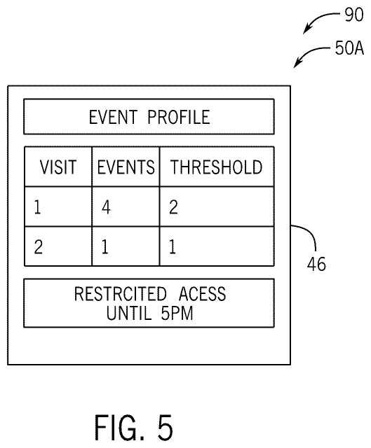

FIG. 5 is an example of a graphical user interface (GUI) 90 that presents the first guest event profile 50A for the first guest 12A of FIG. 4. For example, the first guest event profile 50A may include a table that indicates, for each visit, a quantity of events and/or a threshold. In an embodiment, the first guest event profile 50A may also provide a notification of the one or more restrictions implemented for the first guest 12A, such as blocked or restricted access for some period of time. The GUI 90 may be presented on a display screen, such as the display screen of the guest device 46. However, as noted herein, such information may additionally or alternatively be provided via the display screen of the second portable device 16B of FIG. 4. In an embodiment, additional details may be presented, such as upon selection of a particular visit in the table. For example, upon selection of the first visit in the table, the GUI 90 may present details of each of the handling events, such as a respective type and/or a respective timestamp, as shown in FIG. 2.

While examples herein describe tracking improper handling events on a per visit basis and comparing the improper handling events on the per visit basis to the threshold, it should be appreciated that additionally or alternatively the improper handling events over multiple visits may be summed and/or otherwise considered together. For example, the guest 12 may cause two improper handling events in the interactive environment 14, and then the guest 12 may cause two more improper handling events in an additional interactive environment (e.g., within some period of time, such as during one hour, one day, one visit to the venue with the interactive environment 14 and the additional interactive environment). Further, if the threshold is set to four events, neither the respective visit to the interactive environment 14 nor the respective visit to the additional interactive environment would trigger the one or more restrictions. However, if the threshold is set to four and the improper handling events over the multiple visits to the interactive environment 14 and the additional interactive environment are summed and/or otherwise considered together, this may trigger the one or more restrictions. In an embodiment, the processor 34 may set or utilize one threshold on a per visit basis and may also set or utilize one or more other thresholds for multiple visits. In this way, the processor 34 may identify the guest 12 that habitually or repeatedly improperly handles portable devices, and may also initiate consequences for various combinations of improper handling events.

It should be appreciated that features shown in FIGS. 1-5 and described with reference to FIGS. 1-5 may be combined in any suitable manner. Further, as described herein, UWB circuitry may be utilized to determine position, orientation, acceleration, and/or velocity. Thus, it should be appreciated that UWB circuitry may be used instead of IMUs in any examples that refer to use of IMUs to determine position, orientation, acceleration, and/or velocity.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An event detection system, comprising:
processing circuitry comprising one or more processors; and
memory storing instructions that, when executed by the processing circuitry, cause the processing circuitry to:
process positioning data for a portable device to identify an occurrence of an improper handling event for the portable device by a user;
update a user event profile for the user by adding the improper handling event to a quantity of improper handling events for the portable device by the user; and
in response to determining that the quantity of improper handling events for the portable device by the user meets or exceeds an event threshold, apply one or more restrictions for the user.

2. The event detection system of claim 1, wherein the instructions, when executed by the processing circuitry, cause the processing circuitry to:
set the event threshold based on a history of prior improper handling events by the user during prior visits to one or more interactive environments.

3. The event detection system of claim 1, wherein the instructions, when executed by the processing circuitry, cause the processing circuitry to:
set the event threshold based on a time of a day, a special occasion, or any combination thereof.

4. The event detection system of claim 1, wherein the instructions, when executed by the processing circuitry, cause the processing circuitry to:
in response to identifying the occurrence of the improper handling event for the portable device by the user, instruct an output device of the portable device to provide an alert.

5. The event detection system of claim 1, wherein the one or more restrictions comprise decreasing operational features of the portable device.

6. The event detection system of claim 1, wherein the one or more restrictions comprise blocking the user from reaching achievements in an interactive environment.

7. The event detection system of claim 1, wherein the portable device comprises a targeting device, and the one or more restrictions comprise reducing a quantity of virtual projectiles available to the portable device, changing a type of virtual projectiles available to the portable device, or both.

8. The event detection system of claim 1, wherein the one or more restrictions include blocking access to one or more queues for one or more interactive environments, increasing wait times for the one or more interactive environments, or both.

9. The event detection system of claim 1, wherein the instructions, when executed by the processing circuitry, cause the processing circuitry to:
instruct a respective display of a user device of the user, a respective display of the portable device, or both, to display an indication of the user event profile for the user, the one or more restrictions, or both.

10. The event detection system of claim 1, wherein the instructions, when executed by the processing circuitry, cause the processing circuitry to:
link a user identifier received from a user device of the user with a device identifier received from the portable device;
access a user profile that includes the user event profile for the user based on the user identifier received from the user device of the user;
update the user event profile for the user to generate an updated user event profile for the user by adding the improper handling event to the quantity of improper handling events for the portable device by the user; and
store the updated user event profile for the user in a database.

11. The event detection system of claim 1, wherein the portable device is configured to facilitate interactions with interactive elements in an interactive environment, and the portable device comprises a handheld targeting device, a wand, a toy, a figurine, an article of clothing, a wearable accessory, augmented reality (AR) glasses, virtual reality (VR) glasses, or any combination thereof.

12. The event detection system of claim 1, wherein the positioning data comprises a signal generated by ultra-wideband (UWB) circuitry.

13. The event detection system of claim 12, comprising UWB readers in an interactive environment that are configured to read UWB tags in the portable device to generate the positioning data.

14. An interactive system, comprising:
a processing circuitry comprising one or more processors; and
memory storing instructions that, when executed by the processing circuitry, cause the processing circuitry to:
dynamically set an event threshold;
process respective data for a first portable device utilized during a respective first visit of a first user to a first interactive environment to identify an occurrence of a handling event for the first portable device by the first user;
update a user event profile for the first user by adding the handling event to a quantity of handling events by the first user; and
in response to determining that the quantity of handling events meets or exceeds the event threshold, apply one or more restrictions for the user or one or more enhancements for the user.

15. The interactive system of claim 14, wherein the instructions, when executed by the processing circuitry, cause the processing circuitry to:
process respective data for a second portable device utilized during a respective second visit of the first user to the first interactive environment or to a second interactive environment to identify an occurrence of an additional handling event for the second portable device by the first user;
update the user event profile for the first user by adding the additional handling event to the quantity of handling events by the first user; and
in response to determining that the quantity of handling events meets or exceeds the event threshold, apply the one or more restrictions for the user or the one or more enhancements for the user.

16. The interactive system of claim 14, wherein the instructions, when executed by the processing circuitry, cause the processing circuitry to:
compare the quantity of handling events to the event threshold on a per visit basis.

17. The interactive system of claim 14, wherein the instructions, when executed by the processing circuitry, cause the processing circuitry to:
set the event threshold to be specific to the first user.

18. A method of operating an event detection system, the method comprising:
processing, using one or more processors, positioning data for a portable device to identify an occurrence of an improper handling event for the portable device;
updating, using the one or more processors, an event profile by adding the improper handling event to a quantity of improper handling events for the portable device; and
applying, using the one or more processors, one or more restrictions in response to determining that the quantity of improper handling events for the portable device meets or exceeds an event threshold.

19. The method of claim 18, comprising setting, using the one or more processors, the event threshold based on a history of prior improper handling events during prior visits to one or more interactive environments.

20. The method of claim 18, comprising applying, using the one or more processors, the one or more restrictions via decreasing operational features of the portable device, reducing a quantity of virtual projectiles available to the portable device, changing a type of virtual projectiles available to the portable device, or any combination thereof.
